(19) United States
(12) Patent Application Publication
(10) Pub. No.: US 2025/0079865 A1
(43) Pub. Date: Mar. 6, 2025

(54) CHARGING SYSTEMS AND ASSOCIATED METHODS

(71) Applicant: Analog Devices, Inc., Wilmington, MA (US)

(72) Inventor: Ananthakrishnan Viswanathan, San Jose, CA (US)

(21) Appl. No.: 18/793,835

(22) Filed: Aug. 4, 2024

Related U.S. Application Data
(60) Provisional application No. 63/580,689, filed on Sep. 5, 2023.

(51) Int. Cl. H02J 7/00; H02J 7/34

(52) U.S. Cl. CPC H02J 7/0068; H02J 7/342; H02J 2207/20

(57) ABSTRACT

A charging system includes a first input switching device configured to selectively electrically couple a system node to a first input power source, a diode device configured to electrically couple the system node to one or more loads, an energy storage device, a direct-current-to-direct-current (DC-to-DC) converter, and a controller. The DC-to-DC converter is electrically coupled between the system node and the energy storage device. The controller is configured to control operation of at least the first input switching device and the DC-to-DC converter to enable the charging system to operate in at least (a) a first operating mode being at least partially characterized by the DC-to-DC converter charging the energy storage device with energy from the first input power source or (b) a second operating mode being at least partially characterized by the DC-to-DC converter powering the one or more loads using energy stored in the energy storage device.

### RELATED APPLICATIONS

This application claims benefit of U.S. Provisional Patent Application No. 63/580,689, filed on Sep. 5, 2023, which is incorporated herein by reference.

### BACKGROUND

Charging systems are used, for example, to charge portable electronic devices, such as hearing aids, wireless earbuds, smart watches, mobile phones, etc. A charging system commonly includes a battery to enable the charging system to charge a device even when the charging system is not connected to an external power source, such as when a user of the charging system is “on the go” (OTG).

### BRIEF DESCRIPTION OF THE DRAWINGS

FIG. 1 is a schematic diagram of an electrical environment including a charging system, according to an embodiment.

FIG. 2 is a schematic diagram of an embodiment of the FIG. 1 electrical environment where an energy storage device is embodied by two batteries electrically coupled in series.

FIG. 3 illustrates one example of energy flow in the FIG. 1 charging system in a first operating mode of the charging system.

FIG. 4 illustrates one example of control signals in the FIG. 1 charging system in the first operating mode of the charging system.

FIG. 5 illustrates one example of energy flow in the FIG. 1 charging system in a second operating mode of the charging system.

FIG. 6 illustrates one example of control signals in the FIG. 1 charging system in the second operating mode of the charging system.

FIG. 7 illustrates one example of energy flow in the FIG. 1 charging system in a third operating mode of the charging system.

FIG. 8 illustrates one example of control signals in the FIG. 1 charging system in the third operating mode of the charging system.

FIG. 9 is a schematic diagram of an alternate embodiment of the FIG. 1 electrical environment including a direct-current-to-direct-current (DC-to-DC) converter having extended functionality.

FIG. 10 illustrates one example of control signals for the DC-to-DC converter of the FIG. 9 electrical environment.

FIG. 11 illustrates another example of control signals for the DC-to-DC converter of the FIG. 9 electrical environment.

FIG. 12 is a schematic diagram of an alternate embodiment of the FIG. 9 electrical environment that is configured to individually control powering of two different loads.

FIG. 13 is a schematic diagram of an alternate embodiment of the FIG. 1 electrical environment where a second input power source is omitted.

FIG. 14 is a schematic diagram of an electrical environment including a charging cradle, where the charging cradle includes an embodiment of a charging system of FIG. 12.

### DETAILED DESCRIPTION OF THE EMBODIMENTS

Conventional charging systems include two or more inductors, as well as a large quantity of switching devices, as part of their power conversion circuitry. Inductors are relatively large and costly, which contributes to charging system size and cost. Additionally, while switching devices may be smaller than inductors, switching devices also contribute to charging system size and cost. Furthermore, the power conversion circuitry of conventional charging systems forms two or more direct-current-to-direct-current (DC-to-DC) converters which may simultaneously operate and thereby impair charging system efficiency, as each operating DC-to-DC converter will contribute to charging system power loss.

Disclosed herein are new charging systems and associated methods which may at least partially overcome the above discussed drawbacks of conventional charging systems. For example, certain embodiments of the new charging systems only require a single inductor, which helps achieve small charging system size and low charging system cost. Additionally, particular embodiments of the new charging systems require fewer switching devices than conventional charging systems of similar functionality, which further helps achieve small charging system size and cost. Furthermore, some embodiments only require a single DC-to-DC converter, which promotes efficient charging system operation. Accordingly, the new charging systems and associated methods significantly advance the state of the art of charging systems.

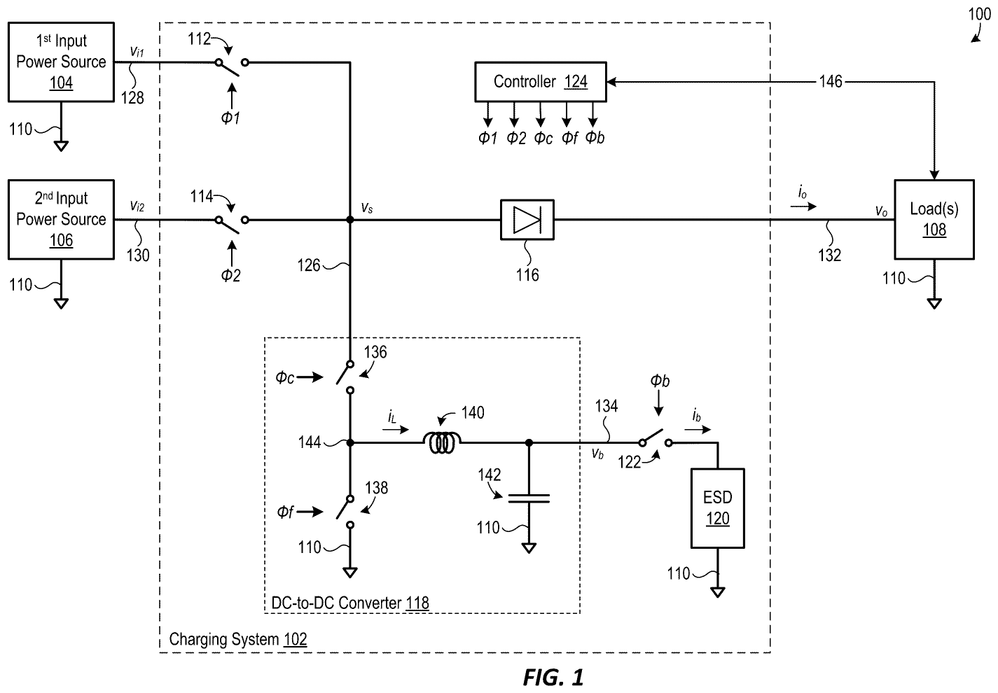

FIG. 1 is a schematic environment of an electrical environment 100 including a charging system 102, a first input power source 104, a second input power source 106, and one or more loads 108, where charging system 102 is one embodiment of the new charging systems disclosed herein. In certain embodiments, first input power source 104 includes an Universal Serial Bus (USB) power source, and second input power source 106 includes a wireless charging power source, such as a wireless charging power source configured to receive energy via an externally generated magnetic field. However, the configuration of first input power source 104 and second input power source 106 may vary as a design choice. Additionally, it should be noted that first input power source 104 and/or second input power source 106 are not necessarily always present in electrical environment 100, and first input power source 104 and second input power source 106 therefore may be unavailable for use by charging system 102 from time to time. For example, certain embodiments of charging system 102 are portable, and a user of charging system 102 may move charging system 102 away from first input power source 104 and second input power source 106, such as when the user of charging system 102 is “on the go” (OTG).

Loads 108 include, for example, one or more portable electronic devices, such as hearing aids, wireless earbuds, smart watches, mobile phones, etc. First input power source 104, second input power source 106, and loads 108 are depicted as being electrically referenced to a reference node 110, which is denoted by a downward pointing triangle. In some embodiments, reference node 110 is a ground node, such as an earth ground node or a chassis ground node. In other embodiments, reference node 110 is floating with respect to a ground node, or stated differently, reference node 110 may be at a different electrical potential than earth ground or another ground node.

As discussed further below, charging system 102 is configured to power loads 108, e.g., for charging one or more batteries (not shown) of loads 108, from energy received from either first input power source 104 or second input power source 106. Additionally, charging system 102 is configured to power loads 108 from energy stored in charging system 102 when first input power source 104 and second input power source 106 are unavailable, such as when a user of charging system 102 is OTG and charging system 102 is therefore away from first input power source 104 and second input power source 106.

Charging system 102 includes a first input switching device 112, a second input switching device 114, a diode device 116, a DC-to-DC converter 118, an energy storage device 120, a battery switching device 122, and a controller 124. In this document, a “switching device” is device that is capable of operating in at least an open state and a closed state in response to a control signal. Accordingly, a switching device can selectively electrically couple two or more nodes and/or two or more devices, in response to a control signal. In particular, a switching device electrically couples two or more nodes and/or two or more devices by closing in response to a control signal commanding the switching device to close, and a switching device electrically decouples two or more nodes and/or two or more devices by opening in response to a control signal commanding the switching device to open. In some embodiments, each switching device disclosed herein includes one or more transistors, such as one or more field effect transistors (FETs), one or more bipolar junction transistors (BJTs), one or more insulated gate bipolar junction transistors (IGBTs), etc. For example, a switching device that need not be capable of preventing reverse current flow may include a single FET, while a switching device that must be capable of preventing reverse current flow may include an N-channel FET electrically coupled in series with a P-channel FET to prevent undesired FET body diode current conduction.

First input power source 104 is electrically coupled to a first input power node 128, and first input power source 104 drives first input power node 128 to an input voltage vᵢ₁. First input switching device 112 is electrically coupled between first input power node 128 and system node 126, and first input switching device 112 is accordingly configured to selectively electrically couple system node 126 to first input power source 104 in response to a control signal ϕ1 generated by controller 124. Similarly, second input power source 106 is electrically coupled to a second input power node 130, and second input power source 106 is configured to drive second input power node 130 to an input voltage vᵢ₂. Second input switching device 114 is electrically coupled between second input power node 130 and system node 126, and second input switching device 114 is accordingly configured to selectively electrically couple system node 126 to second input power source 106 in response to a control signal ϕ2 generated by controller 124.

Loads 108 are electrically coupled to an output power node 132, and diode device 116 is electrically coupled between system node 126 and output power node 132. Diode device 116 is configured to enable an output current iₒ flowing through diode device 116 to flow in only a single direction, i.e., from system node 126 to output power node 132 (left to right in FIG. 1), such as for powering loads 108. In some embodiments, diode device 116 includes one or more diodes, and in some other embodiments, diode device 116 includes one or more transistors configured to operate as diodes. Furthermore, in particular embodiments, diode device 116 includes one or more transistors controlled by controller 124 via one or more control signals (not shown) to emulate a diode.

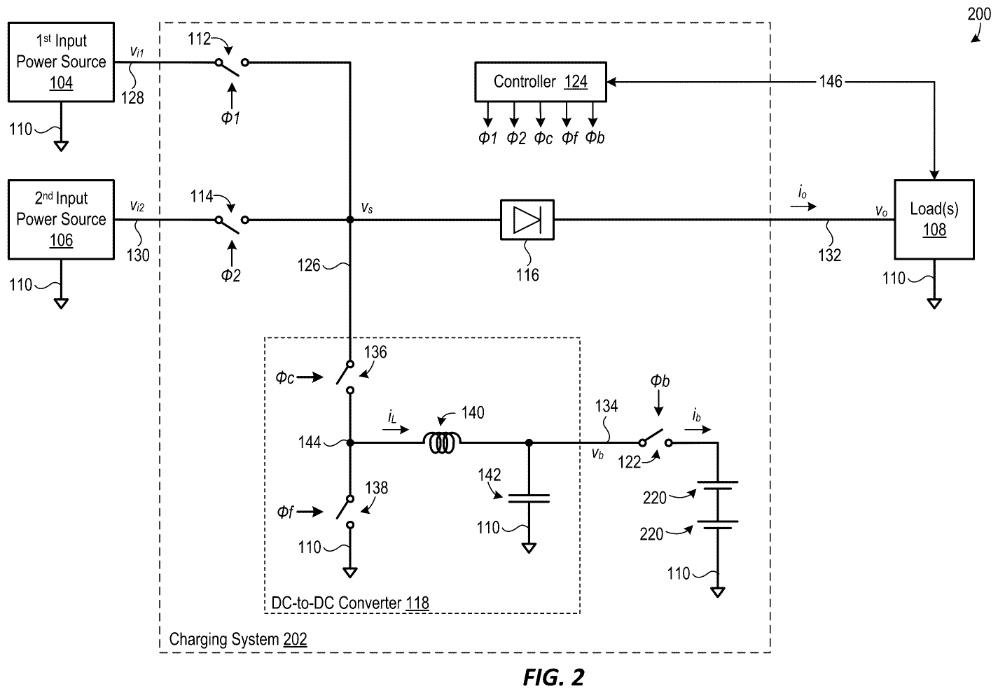

DC-to-DC converter 118 is electrically coupled between system node 126 and a battery node 134. Battery switching device 122 is electrically coupled between battery node 134 and energy storage device 120, and DC-to-DC converter 118 is accordingly electrically coupled between system node 126 and energy storage device 120 via battery switching device 122. Battery switching device 122 is configured to selectively electrically couple energy storage device 120 to battery node 134 in response to a control signal ϕb generated by controller 124. In some embodiments, controller 124 is configured to cause energy storage device 120 to be disconnected from battery node 134 in response to an abnormal condition, such as in response to an overload, overcurrent, and/or overtemperature condition of energy storage device 120. Energy storage device 120 includes, for example, one more elements capable of storing energy, such as one or more batteries, one or more capacitors, etc. For example, FIG. 2 is a schematic diagram of an electrical environment 200, which is an embodiment of electrical environment 100 including charging system 102 embodied as a charging system 202. Energy storage device 120 is embodied in charging system 202 by two batteries 220 electrically coupled in series. It is understood, though, that charging system 202 could be modified to include only a single battery 220, or three or more batteries 220 electrically coupled in series without departing from the scope hereof. Additionally, in embodiments of charging system 202 including a plurality of batteries 220, the batteries could be electrically coupled in parallel, or electrically coupled in a parallel-series combination, instead of being electrically coupled in series.

Referring again to FIG. 1, DC-to-DC converter 118 includes a control switching device 136, a freewheeling switching device 138, an inductor 140, and a capacitor 142. Control switching device 136 is electrically coupled between system node 126 and a switching node 144, and freewheeling switching device 138 is electrically coupled between switching node 144 and reference node 110. Control switching device 136 is configured to selectively electrically coupled system node 126 to switching node 144 in response to a control signal ϕe generated by controller 124, and freewheeling switching device 138 is configured to selectively electrically couple switching node 144 to reference node 110 in response to a control signal ϕf generated by controller 124. Inductor 140 is electrically coupled between switching node 144 and battery node 134, and capacitor 142 is electrically coupled between battery node 134 and reference node 110.

Controller 124 is configured to generate control signals ϕc and ϕf to control operation of DC-to-DC converter 118. Specifically, controller 124 is configured to generate control signal ϕc, such as using a pulse width modulation (PWM) technique or a pulse frequency modulation (PFM) technique, for example, to (a) regulate magnitude of a voltage v_{b} at battery node 134, or magnitude of a current i_{b} flowing to energy storage device 120, when charging energy storage device 120 from energy received from first input power source 104 and/or second input power source 106, or (b) regulate magnitude of a voltage vₛ at system node 126, or magnitude of current iₒ, when powering loads 108 from energy stored in energy storage device 120. Controller 124 is configured to generate control signal ϕf such that freewheeling switching device 138 provides a path for current i_{L} flowing through inductor 140 when control switching device 136 is in its open state. In some alternate embodiments, freewheeling switching device 138 is replaced with, or supplemented by, a diode.

Controller 124 is formed, for example, of analog and/or digital electronic circuitry, and controller 124 is configured to generate each of control signals ϕ1, ϕ2, ϕc, ϕf, and ϕb. Communication links between controller 124 and switching devices of charging system 102 are not shown for illustrative clarity. Controller 124 is optionally communicatively coupled 146 with loads 108, such as to enable controller 124 to control operation of charging system 102 in response to requirements of loads 108. In certain embodiments, controller 124 is communicatively coupled 146 with loads 108 using a power line communication (PLC) communication link, such as via output power node 132. As such, optional communicative coupling 146 may represent a logical communication link instead of a physical communication link. Additionally, certain embodiments of controller 124 are capable of determining status, e.g., availability, of one or more or more of first input power source 104 and second input power source 106. Although controller 124 is depicted as being a single element, controller 124 could be embodied by multiple elements. Additionally, in certain alternate embodiments, controller 124 is at least partially external to charging system 102. For example, charging system 102 could be modified so that controller 124 is at least partially integrated in one or more of first input power source 104, second input power source 106, and load(s) 108.

Controller 124 is configured to control operation of charging system 102 such that charging system 102 may operate in any one of at least at a first operating mode, a second operating mode, and a third operating mode, discussed below, such as based on availability of first input power source 104 and/or second input power source 106, as well optionally based on requirements of loads 108.

### First Operating Mode

The first operating mode of charging system 102 is characterized by controller 124 controlling each of first input switching device 112, second input switching device 114, DC-to-DC converter 118, and battery switching device 122 such that (a) DC-to-DC converter 118 charges energy storage device 120 with energy from first input power source 104 via first input switching device 112, (b) loads 108 are powered from energy from first input power source 104 via first input switching device 112 and diode device 116, and (c) second input power source 106 is isolated from system node 126. Accordingly, controller 124 causes (a) first input switching device 112 to operate in its closed state, (b) second input switching device 114 to operate in its open state, (c) battery switching device 122 to operate in its closed state, and (d) DC-to-DC converter 118 to regulate magnitude of voltage v_{b} and/or magnitude of current i_{b} flowing to energy storage device 120 to charge energy storage device 120. Voltage vₛ at system node 126, as well as voltage vₒ at output power node 132, will be equal to voltage vᵢ₁ at input power node 128, neglecting effects of parasitic impedance in charging system 102, in the first operating mode. DC-to-DC converter 118 operates as a buck converter in the first operating mode, and magnitude of voltage v_{b} will therefore be less than or equal to magnitude of voltage vₛ.

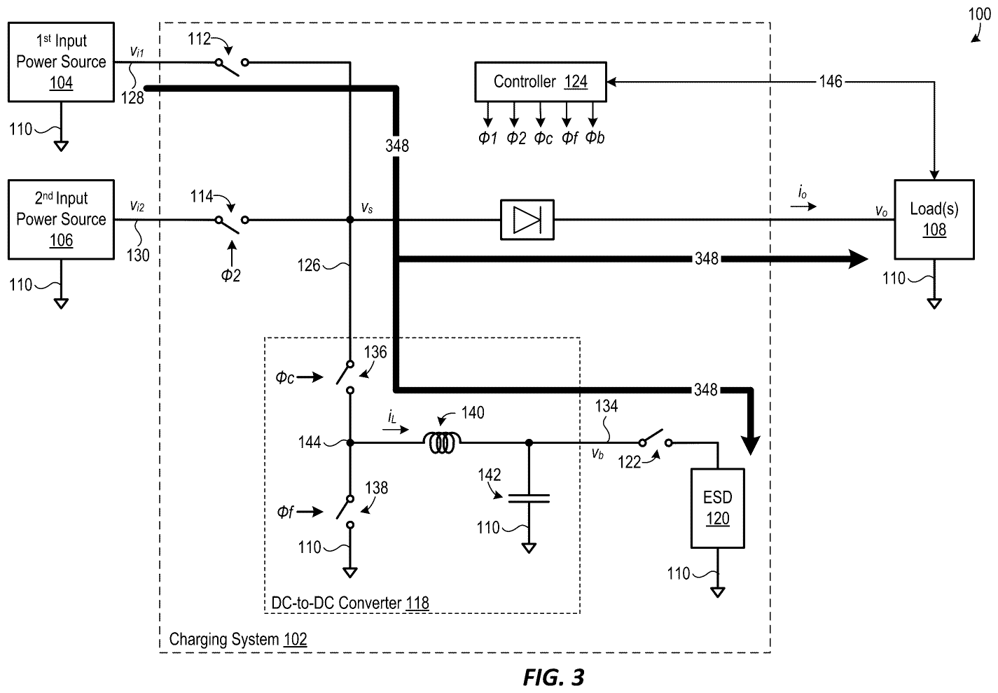

FIG. 3 is a schematic diagram of electrical environment 100 illustrating one example of operation of charging system 102 in its first operating mode. FIG. 3 includes heavy lines 348 symbolically showing that charging system 102 is configured to transfer energy from first input power source 104 to loads 108, as well as that charging system 102 is configured to charge energy storage device 120 with energy from first input power source 104, in the first operating mode of charging system 102.

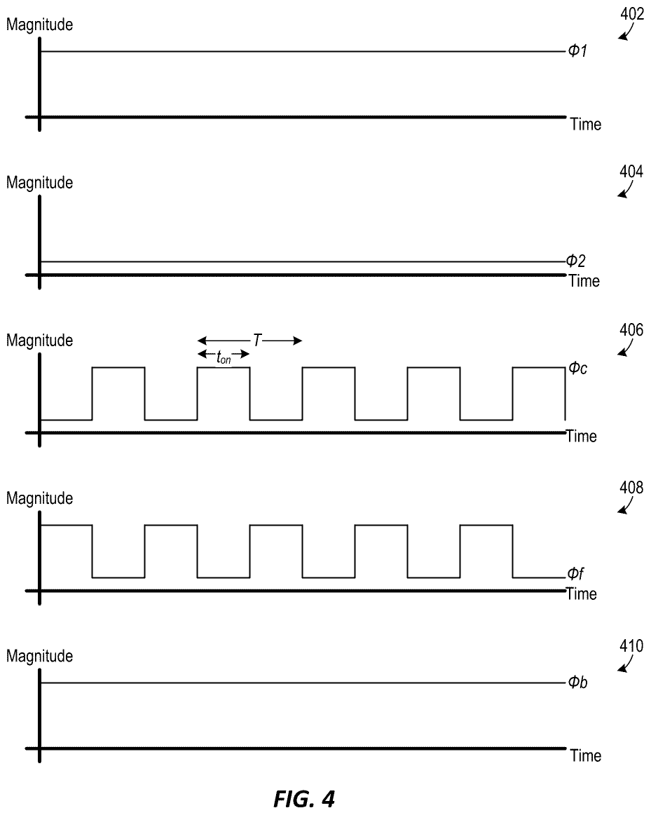

FIG. 4 includes five graphs 402, 404, 406, 408, and 410 respectively illustrating one example of how controller 124 may generate control signals ϕ1, ϕ2, ϕc, ϕf, and ϕb in the first operating mode of charging system 102. Each of graphs 402, 404, 406, 408, and 410 is of signal magnitude versus time, and each of graphs 402, 404, 406, 408, and 410 share a common time base. Graphs 402, 404, 406, 408, and 410 assume that each switching device of charging system 102 is (a) closed when its respective control signal is in a logic high state and (b) open when its respective control signal is in a logic low state. For example, first input switching device 112 is closed when control when control signal ϕ1 is in its logic high state, and first input switching device 112 is open when control signal ϕ7 is in its logic low state, in the FIG. 4 example. However, control signals ϕ1, ϕ2, ϕc, ϕf, and ϕb may have different polarities, and switching devices of charging system 102 may respond to control signals in different manners, without departing from the scope hereof.

In the example of FIG. 4, control signals ϕ1 and ϕb are continuously logic high, and first input switching device 112 and battery switching device 122 therefore continuously operate in their respective closed states. Additionally, control signal ϕ2 is continuously logic low, and second input switching device 114 therefore continuously operates in its open state. Further, control signal ϕc switches between logic high and logic low states with a duty cycle of tₒₙ/T and at a constant frequency of 1/T. Additionally, control signal ϕc is complementary to control signal ϕf, such that DC-to-DC converter 118 operates in a continuous current conduction mode. It is understood, though, that FIG. 4 is not meant to constrain DC-to-DC converter 118 to any particular duty cycle or to any particular mode of operation. For example, DC-to-DC converter 118 may instead operate in a variable frequency mode and/or in a discontinuous current conduction mode. Actual operation of DC-to-DC converter 118 is, for example, implementation dependent and/or operating environment dependent.

### Second Operating Mode

The second operating mode of charging system 102 is characterized by controller 124 controlling each of first input switching device 112, second input switching device 114, DC-to-DC converter 118, and battery switching device 122 such that (a) DC-to-DC converter 118 powers loads 108 via diode device 116 from energy stored in energy storage device 120, (b) first input power source 106 is isolated from system node 126, and (c) second input power source 106 is isolated from system node 126. Accordingly, controller 124 causes (a) first input switching device 112 to operate in its open state, (b) second input switching device 106 to operate in its open state, (c) battery switching device 122 to operate in its closed state, and (d) DC-to-DC converter 118 to regulate magnitude of voltage vₛ and/or magnitude of current iₒ flowing to loads 108. The second operating mode may be used, for example, when a user of charging system 102 is OTG. DC-to-DC converter 118 operates as a boost converter in the second operating mode, and magnitude of voltage vₛ will therefore be greater than or equal to magnitude of voltage v_{b}. Magnitude of voltage vₒ is equal to magnitude of voltage vₛ, neglecting effects of parasitic impedance of charging system 102.

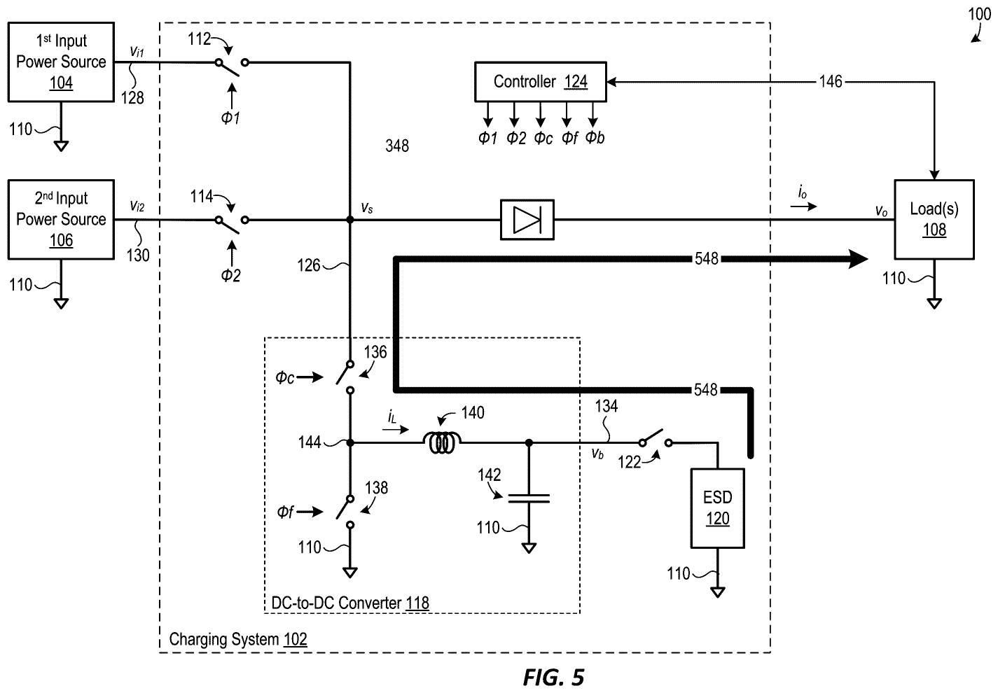

FIG. 5 is a schematic diagram of electrical environment 100 illustrating one example of operation of charging system 102 in its second operating mode. FIG. 5 includes heavy lines 548 symbolically showing that charging system 102 is configured to transfer energy from energy storage device 120 to loads 108, in the second operating mode of charging system 102.

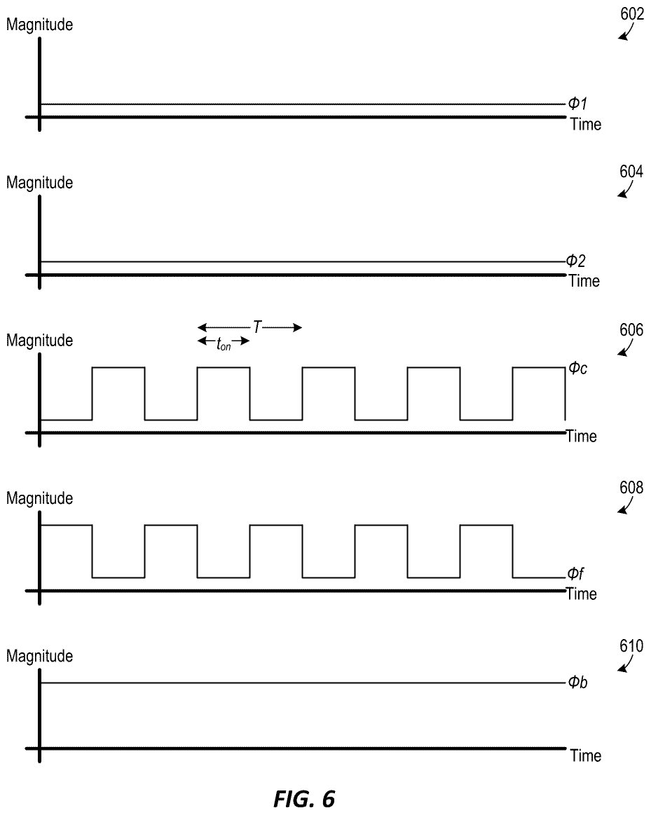

FIG. 6 includes five graphs 602, 604, 606, 608, and 610 respectively illustrating one example of how controller 124 may generate control signals ϕ1, ϕ2, ϕc, ϕf, and ϕb in the second operating mode of charging system 102. Each of graphs 602, 604, 606, 608, and 610 is of signal magnitude versus time, and each of graphs 602, 604, 606, 608, and 610 share a common time base. Graphs 602, 604, 606, 608, and 610 assume that each switching device of charging system 102 is (a) closed when its respective control signal is in a logic high state and (b) open when its respective control signal is in a logic low state, in a manner analogous to that discussed above with respect to FIG. 4. However, control signals ϕ1, ϕ2, ϕc, ϕf, and ϕb may have different polarities, and switching devices of charging system 102 may respond to control signals in different manners, without departing from the scope hereof.

In the example of FIG. 6, control signals ϕ1 and ϕ2 are continuously logic low, and first input switching device 112 and second input switching device 114 therefore continuously operate in their respective open states. Additionally, control signal ϕb is continuously logic high, and battery switching device 122 therefore continuously operates in its closed state. Further, control signal ϕc switches between logic high and logic low states with a duty cycle of tₒₙ/T and a constant frequency of 1/T. Additionally, control signal ϕc is complementary to control signal ϕf, such that DC-to-DC converter 118 operates in a continuous current conduction mode. It is understood, though, that FIG. 6 is not meant to constrain DC-to-DC converter 118 to any particular duty cycle or to any particular mode of operation. For example, DC-to-DC converter 118 may instead operate in a variable frequency mode and/or in a discontinuous current conduction mode. Actual operation of DC-to-DC converter 118 is, for example, implementation dependent and/or operating environment dependent.

### Third Operating Mode

The third operating mode of charging system 102 is characterized by controller 124 controlling each of first input switching device 112, second input switching device 114, DC-to-DC converter 118, and battery switching device 122 such that (a) DC-to-DC converter 118 charges energy storage device 120 from energy from second input power source 106 via second input switching device 114, (b) loads 108 are powered with energy from second input power source 106 via second input switching device 114 and diode device 116, and (c) first input power source 104 is isolated from system node 126. Accordingly, controller 124 causes (a) first input switching device 112 to operate in its open state, (b) second input switching device 114 to operate in its closed state, (c) battery switching device 122 to operate in its closed state, and (d) DC-to-DC converter 118 to regulate magnitude of voltage v_{b} and/or magnitude of current is flowing to energy storage device 120 to charge energy storage device 120. Voltage vₛ at system node 126, as well as voltage vₒ at output power node 132, will be equal to voltage vᵢ₂ at input power node 130, neglecting effects of parasitic impedance of charging system 102, in the third operating mode. Similar to the first operating mode, DC-to-DC converter 118 operates as a buck converter in the third operating mode, and magnitude of voltage v_{b} will therefore be less than or equal to magnitude of voltage vₛ.

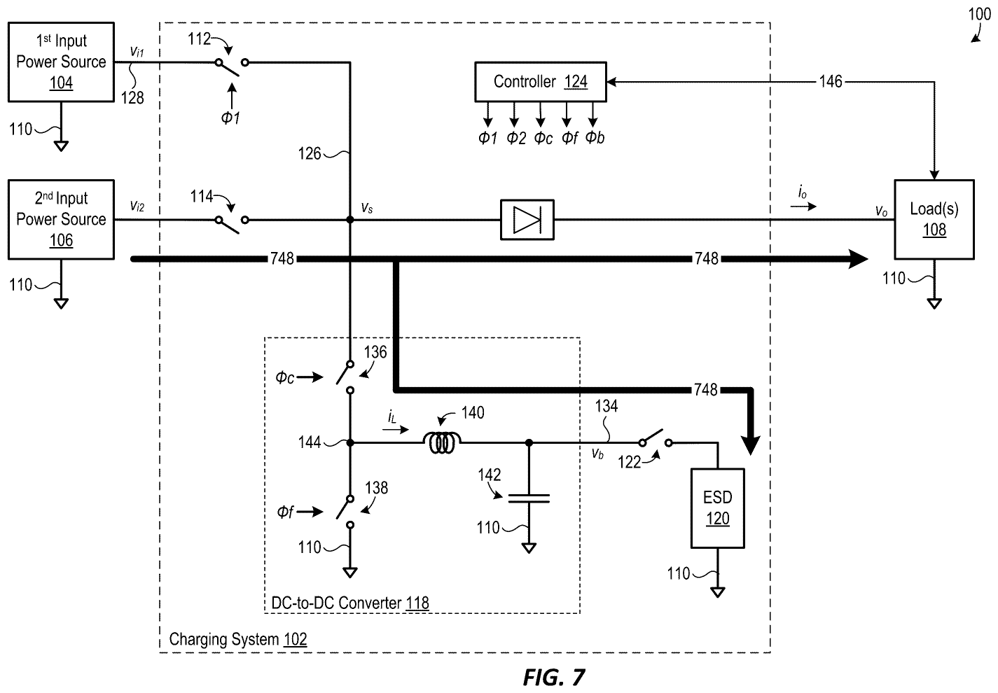

FIG. 7 is a schematic diagram of electrical environment 100 illustrating one example of operation of charging system 102 in its third operating mode. FIG. 7 includes heavy lines 748 symbolically showing that charging system 102 is configured to transfer energy from second input power source 106 to loads 108, as well as that charging system 102 is configured to transfer energy from second input power source 106 to charge energy storage device 120, in the third operating mode of charging system 102.

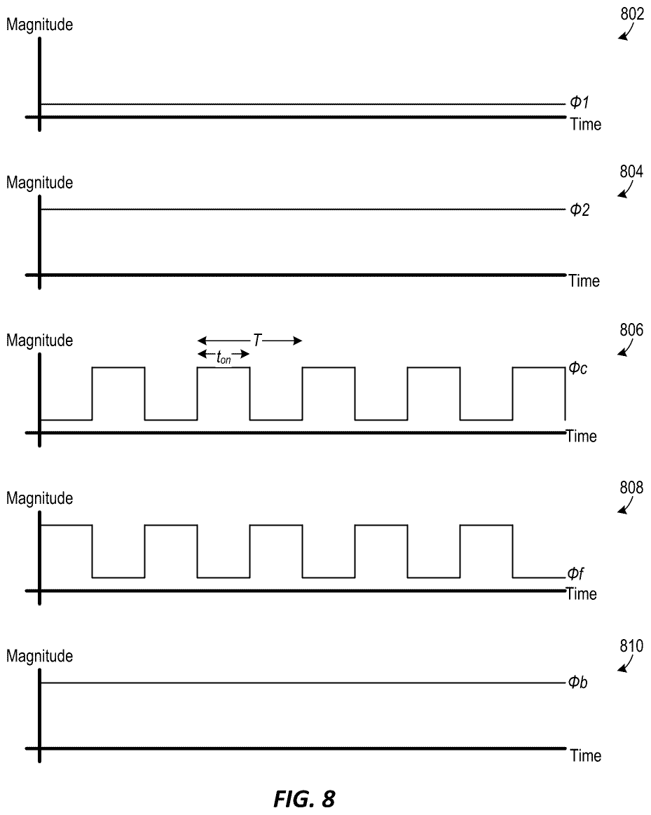

FIG. 8 includes five graphs 802, 804, 806, 808, and 810 respectively illustrating one example of how controller 124 may generate control signals ϕ1, ϕ2, ϕc, ϕf, and ϕb in the third operating mode of charging system 102. Each of graphs 802, 804, 806, 808, and 810 is of signal magnitude versus time, and each of graphs 802, 804, 806, 808, and 810 share a common time base. In a manner analogous to that discussed above with respect to FIG. 4, graphs 802, 804, 806, 808, and 810 assume that each switching device of charging system 102 is (a) closed when its respective control signal is in a logic high state and (b) open when its respective control signal is in a logic low state. However, control signals ϕ1, ϕ2, ϕc, ϕf, and ϕb may have different polarities, and switching devices of charging system 102 may respond to control signals in different manners, without departing from the scope hereof.

In the example of FIG. 8, control signals ϕ2 and ϕb are continuously logic high, and second input switching device 114 and battery switching device 122 therefore continuously operate in their respective closed states. Additionally, control signal ϕ1 is continuously logic low, and second input switching device 112 therefore continuously operates in its open state. Further, control signal ϕc switches between logic high and logic low states with a duty cycle of tₒₙ/T and a constant frequency of 1/T. Additionally, control signal ϕc is complementary to control signal ϕf, such that DC-to-DC converter 118 operates in a continuous current conduction mode. It is understood, though, that FIG. 8 is not meant to constrain DC-to-DC converter 118 to any particular duty cycle or to any particular mode of operation. For example, DC-to-DC converter 118 may instead operate in a variable frequency mode and/or in a discontinuous current conduction mode. Actual operation of DC-to-DC converter 118 is, for example, implementation dependent and/or operating environment dependent.

### Additional Features and Embodiments

Referring again to FIG. 1, it should be appreciated that while charging system 102 is capable of operating in each of the first, second, and third operating modes as discussed above, charging system 102 includes only a single inductor and only five switching devices. Therefore, the configuration of charging system 102 promotes small size, low cost, and efficient operation. It is understood, though, that charging system 102 could be modified to include additional components, such as to add additional functionality, or to omit components, such as if functionality associated with particular components is not required. For example, charging system 102 could be modified to omit control switching device 136 and control either of first input switching device 112 and second input switching device 114 to act as a control switch for DC-to-DC converter 118, such that DC-to-DC converter 118 encompasses first input switching device 112 and second input switching device 114. In these alternate embodiments, first input switching device 112 and second input switching device 114 perform dual functions, i.e., they act as control switching devices as well as selectively electrically couple their respective input power source 104 or 106 to system node 126. Additionally, electrical environment 100 may be modified to include additional elements or fewer elements without departing from the scope hereof. For example, some alternate embodiments of electrical environment 100 include a third input power source, and certain alternate embodiments of electrical environment 100 further include switching circuitry configured to selectively electrically each of a plurality of loads 108 to charging system 102.

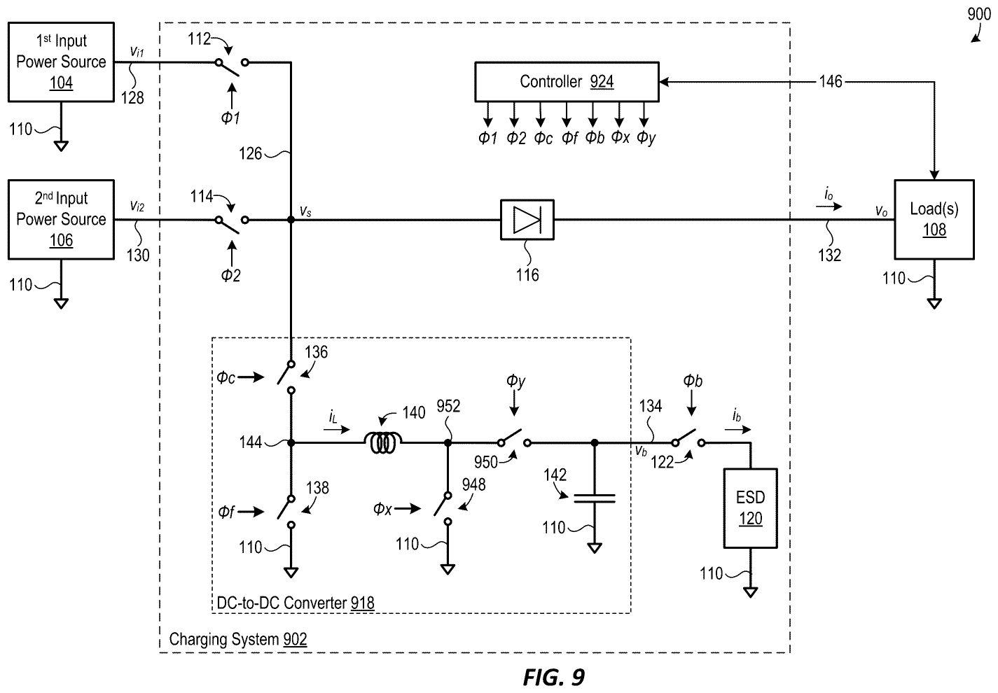

Discussed below with respect to FIGS. 9-13 are several example alternate embodiments of electrical environment 100. It is realized, though, that additional alternate embodiments are possible and are considered within the scope of this disclosure.

FIG. 9 is a schematic diagram of an electrical environment 900, which is an alternate embodiment of electrical environment 900 where charging system 102 is replaced with a charging system 902, which is another embodiment of the new charging systems disclosed herein. Charging system 902 differs from charging system 102 in that (a) DC-to-DC converter 118 is replaced with a DC-to-DC converter 918 and (b) controller 124 is replaced with a controller 924. DC-to-DC converter 918 differs from DC-to-DC converter 118 in that DC-to-DC converter 918 further includes a second control switching device 948 and a second freewheeling switching device 950. Inductor 140 is electrically coupled between switching node 144 and a second switching node 952, and second control switching device 948 is electrically coupled between second switching node 952 and reference node 110. Second freewheeling switching device 950 is electrically coupled between second switching node 952 and battery node 134. Second control switching device 948 is configured to selectively electrically coupled second switching node 952 to reference node 110 in response to a control signal ϕx generated by controller 924, and second freewheeling switching device 950 is configured to selectively electrically couple second switching node 952 to battery node 134 in response to a control signal ϕy generated by controller 924.

Controller 924 is similar to controller 124 of FIG. 1, but controller 924 is further configured to generate control signals ϕx and ϕy. Controller 924 is configured to control operation of charging system 902 such that charging system 902 may operate in any of one at least a first operating mode, a second operating mode, and a third operating mode, in a manner similar to that of charging system 102 of electrical environment 100. However, DC-to-DC converter 918 has functionality in addition to that of DC-to-DC converter 118. To appreciate this additional functionality, consider again DC-to-DC converter 118 of FIG. 1. DC-to-DC converter 118 is configured to operate as a buck converter when charging energy storage device 120, and DC-to-DC converter 118 is configured to operate as a boost converter when powering loads 108 from energy storage device 120, as discussed above. DC-to-DC converter 918 is not only capable of operating in this matter, but DC-to-DC converter 918 is further capable of operating as a boost converter when charging energy storage device 120, as well as operating as a buck converter when powering loads 108 from energy storage device 120. Accordingly, use of DC-to-DC converter 918 in place of DC-to-DC converter 118 provides additional flexibility in setting voltages in charging system 902, which may be particularly beneficial when energy storage device 120 is embodied by a plurality of batteries electrically coupled in series, such as illustrated in FIG. 2.

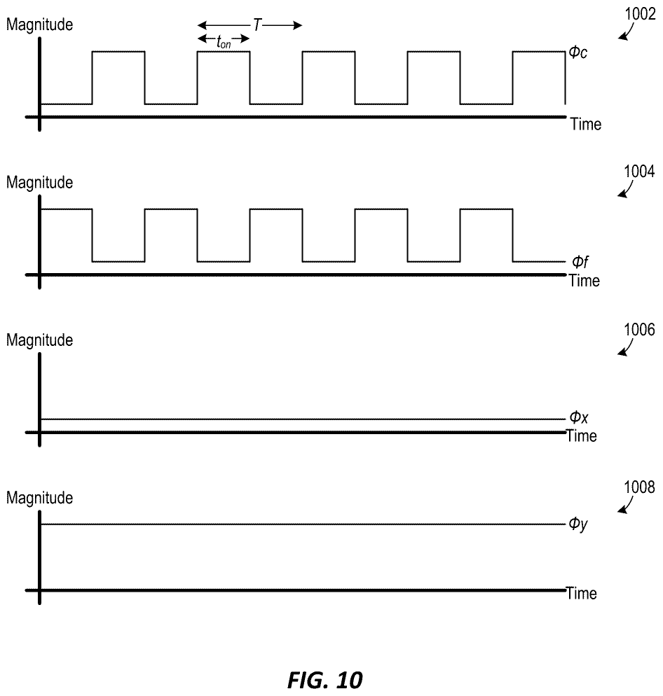

FIG. 10 includes four graphs 1002, 1004, 1006, and 1008 respectively illustrating one example of how controller 924 may generate control signals ϕc, ϕf, ϕx, and ϕy when DC-to-DC converter operates either (a) as a buck converter when charging energy storage device 120 from energy received from one of first input power source 104 and second input power source 106 and (b) a boost converter when powering loads 108 from energy stored in energy storage device 120. Each of graphs 1002, 1004, 1006, and 1008 is of signal magnitude versus time, and each of graphs 1002, 1004, 1006, and 1008 share a common time base. In a manner analogous to that discussed above with respect to FIG. 4, graphs 1002, 1004, 1006, and 1008 assume that each switching device of DC-to-DC converter 918 is (a) closed when its respective control signal is in a logic high state and (b) open when its respective control signal is in a logic low state. However, control signals ϕc, ϕf, ϕx, and ϕy may have different polarities, and switching devices of DC-to-DC converter 918 may respond to control signals in different manners, without departing from the scope hereof.

In the FIG. 10 example, control signal ϕx is continuously logic low, and second control switching device 948 therefore continuously operates in its open state. Additionally, control signal ϕy is continuously logic high, and second freewheeling switching device 950 therefore continuously operates in its closed state. Consequently, DC-to-DC converter 918 controls charging of energy storage device 120, or powering of loads 108, by controlling duty cycle of control switching device 136, such as by using a PWM or PFM technique. For example, in the FIG. 10 example, control signal ϕe switches between logic high and logic low states with a duty cycle of tₒₙ/T and a constant frequency of 1/T. Additionally, control signal ϕc is complementary to control signal ϕf, such that DC-to-DC converter 918 operates in a continuous current conduction mode. It is understood, though, that FIG. 10 is not meant to constrain DC-to-DC converter 918 to operating at any particular duty cycle or to operating in any particular mode. For example, DC-to-DC converter 918 could instead operate in a variable frequency mode and/or in a discontinuous current conduction mode.

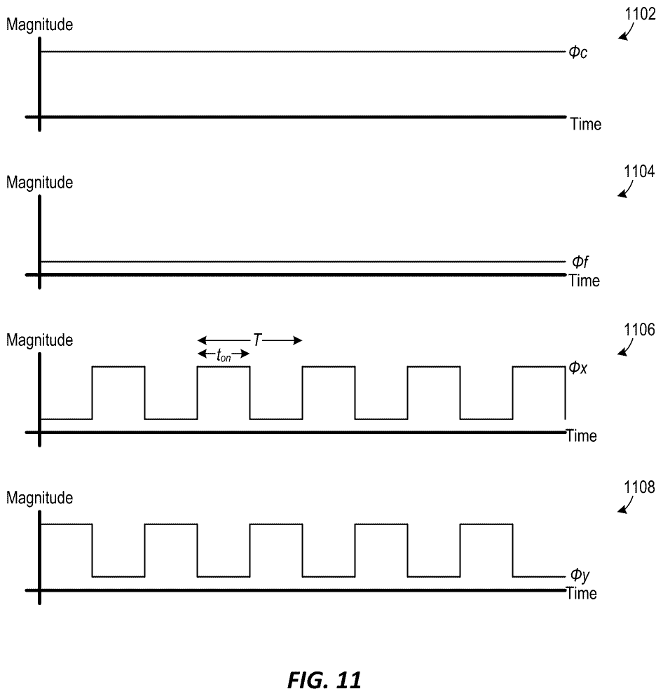

FIG. 11, on the other hand, includes four graphs 1102, 1104, 1106, and 1108 respectively illustrating one example of how controller 924 may generate control signals ϕc, ϕf, ϕx, and ϕy when DC-to-DC converter operates either (a) as a boost converter when charging energy storage device 120 from energy from one of first input power source 104 and second input power source 106 and (b) a buck converter when powering loads 108 from energy stored in energy storage device 120. Each of graphs 1102, 1104, 1106, and 1108 is of signal magnitude versus time, and each of graphs 1102, 1104, 1106, and 1108 share a common time base. In a manner analogous to that discussed above with respect to FIG. 4, graphs 1102, 1104, 1106, and 1108 assume that each switching device of DC-to-DC converter 918 is (a) closed when its respective control signal is in a logic high state and (b) open when its respective control signal is in a logic low state. However, control signals ϕc, ϕf, ϕx, and ϕy may have different polarities, and switching devices of DC-to-DC converter 918 may respond to control signals in different manners, without departing from the scope hereof.

In the FIG. 11 example, control signal ϕc is continuously logic high, and control switching device 136 therefore continuously operates in its open state. Additionally, control signal of is continuously logic low, and freewheeling switching device 138 therefore continuously operates in its closed state. Consequently, DC-to-DC converter 918 controls charging of energy storage device 120, or powering of loads 108, by controlling duty cycle of second control switching device 948 via control signal ϕx, such as by using a PWM or PFM technique. Additionally, controller 924 generates control signal ϕy such that second freewheeling switching device 950 provides a path for current i_{L} flowing through inductor 140 when second control switching device 948 is in its open state. For example, in the FIG. 11 example control signal ϕx switches between logic high and logic low states with a duty cycle of tₒₙ/T and at a constant frequency of 1/T. Additionally, control signal ϕy is complementary to control signal ϕx, such that DC-to-DC converter 918 operates in a continuous current conduction mode. It is understood, though, that FIG. 11 is not meant to constrain DC-to-DC converter 918 to operating at any particular duty cycle or to operating in any particular mode. For example, DC-to-DC converter 918 could instead operate in a variable frequency mode and/or in a discontinuous current conduction mode.

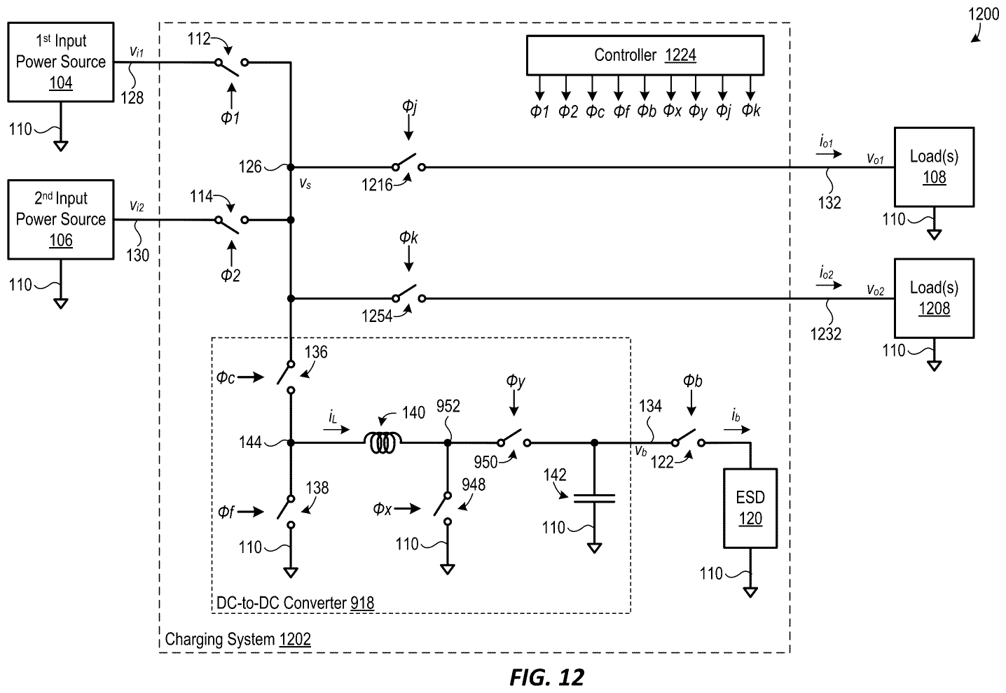

Referring again to FIG. 1, any of the new charging systems disclosed herein could be configured to selectively individually power one or more different loads. For example, FIG. 12 is a schematic diagram of an electrical environment 1200, which is an alternate embodiment of electrical environment 900 (FIG. 9) including (a) a charging system 1202 in place of charging system 902 and (b) one or more second loads 1208. Charging system 1202 includes a controller 1224 in place of controller 924, and charging system 1202 includes a first load switching device in place of diode device 116, i.e., first load switching device 1216 is electrically coupled between system node 126 and output power node 132 in place of diode device 116. Additionally, charging system 1202 includes a second load switching device 1254 electrically coupled between system node 126 and a second output power node 1232, and second loads 1208 are electrically coupled to second output power node 1232. First load switching device 1216 is configured to selectively electrically couple system node 126 to output power node 132 and loads 108 in response to a control signal ϕj generated by controller 1224, and second load switching device 1254 is configured to selectively electrically couple system node 126 to second output power node 1232 and second loads 1208 in response to a control signal ϕk generated by controller 1224.

Controller 1224 is similar to controller 924 except that controller 1224 is further configured to generate control signals ϕj and ϕk to control load switching devices 1216 and 1254, respectively. For example, controller 1224 may generate control signal ϕj to selectively enable powering of loads 108 independently of powering second loads 1208, and controller 1224 may generate control signal ϕk to selectively enable powering of loads 1208 independently of powering second loads 108. Additionally, controller 1224 is configured to generate control signals ϕj and ϕk such that first load switching device 1216 and second load switching device 1254 each emulate a diode. Stated differently, controller 1224 is configured to generate control signal ϕj such that first load switching device 1216 allows current ion flowing from system node 126 to loads 108 to flow solely from left to right, i.e., from system node 126 to output power node 132. Additionally, controller 1224 is configured to generate control signal ϕk such that second load switching device 1254 allows current iₒ₂ flowing from system node 126 to second loads 1208 to flow solely from left to right, i.e., from system node 126 to second output power node 1232.

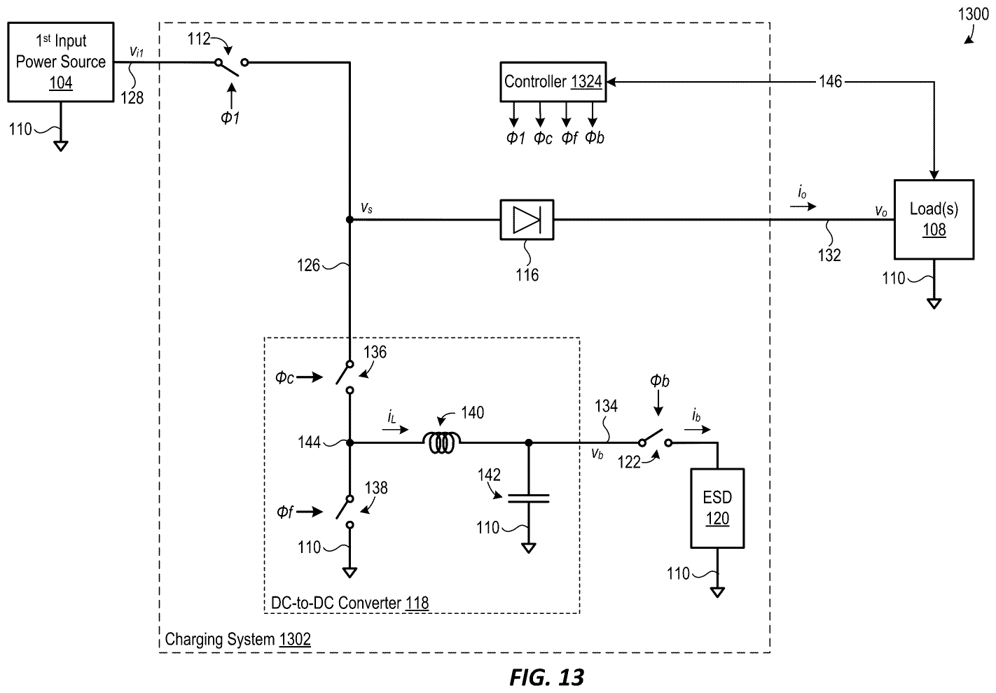

Referring again to FIG. 1, any of the new charging systems disclosed herein could be modified to be powered by a different quantity, and/or by a different type, of input power sources. For example, FIG. 13 is a schematic diagram of an electrical environment 1300, which is an alternate embodiment of electrical environment 100 (FIG. 1) where (a) second input power source 106 is omitted and (b) charging system 102 is replaced with a charging system 1302. Charging system 1302 differs from charging system 102 in that (a) second input switching device 114 is omitted and (b) controller 124 is replaced with a controller 1324. Controller 1324 is similar to controller 124, except that controller 1324 is not capable of generating control signal ϕ2. Accordingly, charging system 1302 operates in the same manner as charging system 102 except that charging system 1302 is not capable of operating in the third operating mode.

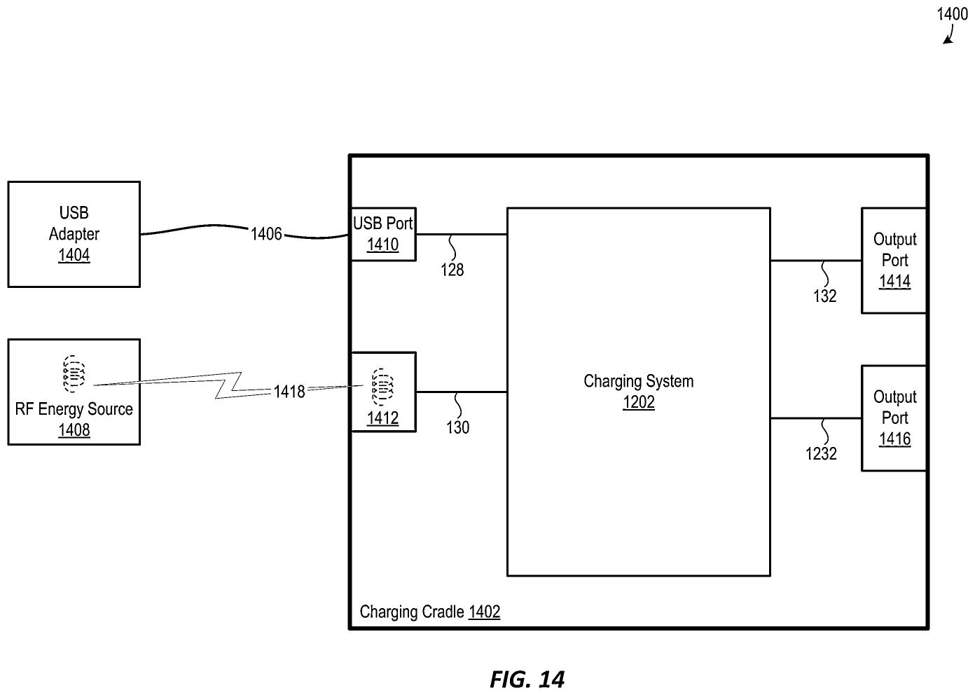

One possible application of the new charging systems disclosed herein is in use in a charging cradle, such as a charging cradle for charging portable electronic devices. For example, FIG. 1400 is a block diagram of an electrical environment 1400 including a charging cradle 1402, an USB adapter 1404, a USB cable 1406, and a radio frequency (RF) energy source 1408. Charging cradle 1402 includes an embodiment of charging system 1202 (FIG. 12), an USB port 1410, a wireless charging port 1412, an output port 1414, and an output port 1416. Details of charging system 1202 are not shown in FIG. 14 for illustrative clarity. USB port 1410 is configured to electrically interface USB adapter 1404 with charging cradle 1402 via USB cable 1406, and USB port 1410 thereby enables charging cradle 1402 to receive electrical power from USB adapter 1404. USB port 1410 is an embodiment of first input power source 104, and USB port 1410 is accordingly electrically coupled to charging system 1202 via first input power node 128.

Wireless charging port 1412 is configured to generate electrical power from a dynamic magnetic field 1418 generated by RF energy source 1408. In some embodiments, wireless charging port 1412 includes a coil, symbolically shown by dashed lines in FIG. 14, for inducement of an electric current by dynamic magnetic field 1418, as well as power regulation circuitry (not shown) to provide a regulated electric power source for charging cradle 1402. Particular embodiments of RF energy source 1408 include a resonant coil, symbolically shown by dashed lines in FIG. 14, for generating dynamic magnetic field 1418 from an external electrical power source (not shown). Wireless charging port 1412 is an embodiment of second input power source 106, and wireless charging port 1412 is accordingly electrically coupled to charging system 1202 via second input power node 130.

Output port 1414 is electrically coupled to output power node 132, and output port 1414 enables a first portable electronic device (not shown), which is an embodiment of one more loads 108, to be powered from charging cradle 1402 via output power node 132. Similarly, output port 1416 is electrically coupled to output power node 1232, and output port 1414 enables a second portable electronic device (not shown), which is an embodiment of one more second loads 1208, to be powered from charging cradle 1402 via second output power node 1232.

### Combinations of Features

Features described above may be combined in various ways without departing from the scope hereof. The following examples illustrate some possible combinations.
(A1) A charging system includes (1) a first input switching device configured to selectively electrically couple a system node to a first input power source, (2) a diode device configured to electrically couple the system node to one or more loads, (3) an energy storage device, (4) a direct-current-to-direct-current (DC-to-DC) converter electrically coupled between the system node and the energy storage device, and (5) a controller. The controller is configured to control operation of at least the first input switching device and the DC-to-DC converter to enable the charging system to operate in any one of at least the following operating modes: (i) a first operating mode being at least partially characterized by the DC-to-DC converter charging the energy storage device with energy from the first input power source and (ii) a second operating mode being at least partially characterized by the DC-to-DC converter powering the one or more loads via the diode device using energy stored in the energy storage device.
(A2) In the charging system denoted as (A1), the first operating mode may be further characterized by the one or more loads being powered from the first input power source via the first input switching device and the diode device.
(A3) In either one of the charging systems denoted as (A1) and (A2), the second operating mode may be further characterized by the first input power source being isolated from the system node.
(A4) In any of the charging systems denoted as (A1) through (A3), (i) the DC-to-DC converter may have a buck topology in the first operating mode, and (ii) the DC-to-DC converter may have a boost topology in the second operating mode.
(A5) In any of the charging systems denoted as (A1) through (A3), (i) the DC-to-DC converter may be capable of having either a buck topology or a boost topology in the first operating mode, and (ii) the DC-to-DC converter may be capable of having either a buck topology or a boost topology in the second operating mode.
(A6) Any one of the charging systems denoted as (A1) through (A5) may further include a battery switching device electrically coupled between the DC-to-DC converter and the energy storage device.
(A7) Any one of the charging systems denoted as (A1) through (A6) may further include a second input switching device configured to selectively electrically couple the system node to a second input power source.
(A8) In the charging system denoted as (A7), the controller may be further configured to control operation of at least the first input switching device, the second input switching device, and the DC-to-DC converter to enable the charging system to operate in any one of at least the first operating mode, the second operating mode, and a third operating mode, the third operating mode being at least partially characterized by the DC-to-DC converter charging the energy storage device with energy from the second input power source.
(A9) In the charging system denoted as (A8), the third operating mode may be further characterized by the one or more loads being powered from the second input power source via the second input switching device and the diode device.
(A10) In either one of the charging systems denoted as (A8) and (A9), the second operating mode may be further characterized by the second input power source being isolated from the system node.
(A11) In any one of the charging systems denoted as (A1) through (A10), the energy storage device may include one or more batteries.
(B1) A charging system includes (1) a first input switching device configured to selectively electrically couple a system node to a first input power source, (2) a first load switching device configured to selectively electrically couple the system node to one or more first loads, (3) an energy storage device, (4) a direct-current-to-direct-current (DC-to-DC) converter electrically coupled between the system node and the energy storage device, and (5) a controller. The controller is configured to control operation of at least the first input switching device, the first load switching device, and the DC-to-DC converter to enable the charging system to operate in any one of at least the following operating modes: (i) a first operating mode being at least partially characterized by the DC-to-DC converter charging the energy storage device with energy from the first input power source and (2) a second operating mode being at least partially characterized by the DC-to-DC converter powering the one or more first loads via the first load switching device using energy stored in the energy storage device.
(B2) In the charging system denoted as (B1), the controller may be further configured to control the first load switching device such that the first load switching device emulates a diode.
(B3) Either one of the charging systems denoted as (B1) and (B2) may further include a second load switching device configured to selectively electrically couple the system node to one or more second loads.
(B4) In the charging system denoted as (B3), the second operating mode may be further characterized by the DC-to-DC converter powering the one or more second loads via the second load switching device using energy stored in the energy storage device.
(B5) In either one of the charging systems denoted as (B3) and (B4), the controller may be further configured to control the second load switching device such that the second load switching device emulates a diode.
(C1) A method for operating a charging system includes (1) transferring energy from a first input power source to an energy storage device via a first input switching device and a direct-current-to-direct-current (DC-to-DC) converter and (2) after transferring energy between the first input power source and the energy storage device, transferring energy from the energy storage device to a load via the DC-to-DC converter and one of a diode device and a first load switching device.
(C2) The method denoted as (C1) may further include, while transferring energy from the first input power source to the energy storage device, transferring energy from the first input power source to the load via the first input switching device and one of the diode device and the first load switching device.
(C3) Either one of the methods denoted as (C1) and (C2) may further include, after transferring energy from the first input power source to the energy storage device, transferring energy from a second input power source to the energy storage device via a second input switching device and the DC-to-DC converter.
(C4) In either one of the methods denoted as (C1) through (C3), the energy storage device may include one or more batteries.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A charging system, comprising:
a first input switching device configured to selectively electrically couple a system node to a first input power source;
a diode device configured to electrically couple the system node to one or more loads;
an energy storage device;
a direct-current-to-direct-current (DC-to-DC) converter electrically coupled between the system node and the energy storage device; and
a controller configured to control operation of at least the first input switching device and the DC-to-DC converter to enable the charging system to operate in any one of at least the following operating modes:
a first operating mode being at least partially characterized by the DC-to-DC converter charging the energy storage device with energy from the first input power source, and
a second operating mode being at least partially characterized by the DC-to-DC converter powering the one or more loads via the diode device using energy stored in the energy storage device.

2. The charging system of claim 1, wherein the first operating mode is further characterized by the one or more loads being powered from the first input power source via the first input switching device and the diode device.

3. The charging system of claim 1, wherein the second operating mode is further characterized by the first input power source being isolated from the system node.

4. The charging system of claim 1, wherein:
the DC-to-DC converter has a buck topology in the first operating mode; and
the DC-to-DC converter has a boost topology in the second operating mode.

5. The charging system of claim 1, wherein:
the DC-to-DC converter is capable of having either a buck topology or a boost topology in the first operating mode; and
the DC-to-DC converter is capable of having either a buck topology or a boost topology in the second operating mode.

6. The charging system of claim 1, further comprising a battery switching device electrically coupled between the DC-to-DC converter and the energy storage device.

7. The charging system of claim 1, further comprising a second input switching device configured to selectively electrically couple the system node to a second input power source.

8. The charging system of claim 7, wherein the controller is further configured to control operation of at least the first input switching device, the second input switching device, and the DC-to-DC converter to enable the charging system to operate in any one of at least the first operating mode, the second operating mode, and a third operating mode, the third operating mode being at least partially characterized by the DC-to-DC converter charging the energy storage device with energy from the second input power source.

9. The charging system of claim 8, wherein the third operating mode is further characterized by the one or more loads being powered from the second input power source via the second input switching device and the diode device.

10. The charging system of claim 8, wherein the second operating mode is further characterized by the second input power source being isolated from the system node.

11. The charging system of claim 1, wherein the energy storage device comprises one or more batteries.

12. A charging system, comprising:
a first input switching device configured to selectively electrically couple a system node to a first input power source;
a first load switching device configured to selectively electrically couple the system node to one or more first loads;
an energy storage device;
a direct-current-to-direct-current (DC-to-DC) converter electrically coupled between the system node and the energy storage device; and
a controller configured to control operation of at least the first input switching device, the first load switching device, and the DC-to-DC converter to enable the charging system to operate in any one of at least the following operating modes:
a first operating mode being at least partially characterized by the DC-to-DC converter charging the energy storage device with energy from the first input power source, and
a second operating mode being at least partially characterized by the DC-to-DC converter powering the one or more first loads via the first load switching device using energy stored in the energy storage device.

13. The charging system of claim 12, wherein the controller is further configured to control the first load switching device such that the first load switching device emulates a diode.

14. The charging system of claim 12, further comprising a second load switching device configured to selectively electrically couple the system node to one or more second loads.

15. The charging system of claim 14, wherein the second operating mode is further characterized by the DC-to-DC converter powering the one or more second loads via the second load switching device using energy stored in the energy storage device.

16. The charging system of claim 14, wherein the controller is further configured to control the second load switching device such that the second load switching device emulates a diode.

17. A method operating a charging system, the method comprising:
transferring energy from a first input power source to an energy storage device via a first input switching device and a direct-current-to-direct-current (DC-to-DC) converter; and
after transferring energy between the first input power source and the energy storage device, transferring energy from the energy storage device to a load via the DC-to-DC converter and one of a diode device and a first load switching device.

18. The method of claim 17, further comprising, while transferring energy from the first input power source to the energy storage device, transferring energy from the first input power source to the load via the first input switching device and one of the diode device and the first load switching device.

19. The method of claim 17, further comprising, after transferring energy from the first input power source to the energy storage device, transferring energy from a second input power source to the energy storage device via a second input switching device and the DC-to-DC converter.

20. The method of claim 17, wherein the energy storage device comprises one or more batteries.
